(19) United States
(12) Patent Application Publication
(10) Pub. No.: US 2023/0018908 A1
(43) Pub. Date: Jan. 19, 2023

(54) FEEDBACK-BASED CONTROL SYSTEM FOR SOFTWARE DEFINED NETWORKS

(71) Applicant: VMware, Inc., Palo Alto, CA (US)

(72) Inventors: Jonathan Yue, Danville, CA (US); Gaurav Rastogi, San Francisco, CA (US); Ashutosh Gupta, San Jose, CA (US); Prajval Bavi, Sunnyvale, CA (US)

(21) Appl. No.: 17/860,044

(22) Filed: Jul. 7, 2022

Related U.S. Application Data
(60) Provisional application No. 63/223,294, filed on Jul. 19, 2021.

(51) Int. Cl. H04L 9/40; H04L 43/024

(52) U.S. Cl. CPC H04L 63/1425; H04L 43/024

(57) ABSTRACT

Some embodiments provide a novel method for dynamically adjusting sampling rates of a middlebox service. In some embodiments, the method is performed by the controller. The method configures the forwarding element to collect samples from packets processed by the forwarding element at a first sampling rate. The method analyzes the samples in order to collect information regarding the packets processed by the forwarding element. Based on the analysis, the method detects a new traffic pattern in the packets processed by the forwarding element. The method then configures the forwarding element to collect samples from packets processed by the forwarding element at a second sampling rate different than the first sampling rate.

### BACKGROUND

Hackers pose significant harm to managing networks. While legitimate Internet users generate normal traffic to a network, malicious users or hackers contrive and send abnormal traffic to the network for the purpose of property theft, network disruption, or any other vicious intentions. One of the biggest challenges in thwarting cyberattacks is distinguishing between malicious and legitimate traffic.

To identify malicious traffic, the Internet community has collected hundreds of rules and used them for blacklisting Internet requests. The rules include keywords, conditions, regular expressions, or other criteria characterizing attack data. Individual rules are matched against incoming traffic for hits and misses. The rules may not block requests directly. Instead, the rules work collaboratively and raise an anomaly score. When all the rules have been executed, a user-defined threshold is applied, and the request is blocked if the score exceeds the threshold. As the number of emerging cyberattacks increases, the knowledgebase of the blacklisting rules grows bigger and bigger, and execution of all the rules becomes more costly. Such a rules-matching process is referred to as deep-inspection because it inspects the traffic comprehensively and thoroughly following all the rules. However, this approach is not always feasible due to time and performance constraints.

### BRIEF SUMMARY

Some embodiments provide a novel method for dynamically adjusting sampling rates of a security service. The method configures a forwarding element to collect samples at a first sampling rate as it processes packets. The method analyzes the samples in order to collect information regarding the packets processed by the forwarding element. Based on the analysis, the method detects a new traffic pattern in the packets processed by the forwarding element. The method then configures the forwarding element to collect samples from packets processed by the forwarding element at a second sampling rate different than the first sampling rate. The method in some embodiments is implemented by a set of one or more controllers that work conjunctively with the forwarding element and other forwarding elements to provide a distributed service (e.g., a middlebox service) in a network. In other embodiments, the method can be implemented by any type of server to collect and analyze samples from any type of forwarding element that processes packets.

The second sampling rate in some embodiments is larger than the first sampling rate and directs the forwarding element to collect a larger number of samples than the first sampling rate. After a transient period of collecting samples at the second sampling rate, the method in some embodiments configures the forwarding element to collect samples from the packets it processes at a third sampling rate that is lower than the second sampling rate. The third sampling rate can be equal to the first sampling rate, or can be a rate between the first and second sampling rates. The third sampling rate causes the forwarding element to collect a smaller number of samples than the second sampling rate because after the transient period, the forwarding element has collected a sufficient number of samples to analyze in order to collect information about the new traffic pattern.

The forwarding element collects samples and forwards them to the controller differently in different embodiments. For instance, in some embodiments, the forwarding element collects samples by copying a subset of packets that the forwarding element processes and forwards the copies to the controller. In other embodiments, the forwarding element collects samples by extracting data from a subset of packets that the forwarding element processes and forwards the extracted data to the controller. Conjunctively, or alternatively, the forwarding element in some embodiments generates metadata from the data that it extracts from a subset of packets that the forwarding element processes, and then forwards the generated metadata to the controller. In some embodiments, the forwarding element forwards to the controller the generated metadata with a portion of the data from the subset of packets.

The method detects a new traffic pattern differently in different embodiments. In some embodiments, the method detects a new traffic pattern by detecting packets from a new source address, packets to a new destination address, and/or packets using new protocols. New source and destination addresses may include new source and destination layer 3 or layer 4 addresses. As used in this document, the term traffic pattern, flow, traffic flow, or packet flow refers to a set of packets or data messages exchanged between a source network address and a destination network address that share identifying characteristics. In some embodiments, the shared characteristics are an n-tuple (e.g., a 5-tuple made up of header fields such as source Internet Protocol (IP) address, source port number, destination IP address, destination port number, and protocol). A traffic pattern includes one or more packets in a specific transport connection in some embodiments.

Configuring the forwarding element to collect samples at the second sampling rate in some embodiments includes generating and forwarding a set of instructions to the forwarding element that includes an adjustment value to change the first sampling rate to the second sampling rate. The adjustment value is computed differently in different embodiments. For instance, the method may analyze the collected samples from the forwarding element to compute an entropy value that determines whether there is a new traffic pattern of packets processed at the forwarding element. In some embodiments, the entropy is calculated by using a set of tokens accumulated from the collected samples that specify parameters of the samples, such as a packet name, length, source, and/or destination. Other parameters may be used in other embodiments. The entropy value of some embodiments may express a summation of probabilities of all traffic patterns in the packets processed by the forwarding element, such that a change in the entropy over time might indicate there is a new traffic pattern.

In some embodiments, the method may use the entropy to compute a dynamic metric value that expresses metrics of the traffic pattern, and the method may collect a workload value that expresses the resource consumption of the system. The dynamic metric value and the workload value can be used in some embodiments to compute two normalized oscillator values that express normalized values for the dynamic metrics value and the workload value, as the initial dynamic metrics and workload values may be large. Using the normalized oscillator values, the method of some embodiments computes the adjustment value to the sampling rate.

In embodiments of the method that configure the forwarding element to collect samples at the third sampling rate, the method can generate and forward a set of instructions to change the second sampling rate to the third sampling rate. This may be generated in a similar way to the set of instructions that change the first sampling rate to the second sampling rate.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 conceptually illustrates a process that implements the method of some embodiments.

FIG. 2 illustrates a middlebox service comprising a forwarding element and a controller that perform methods of some embodiments to dynamically adjust sampling rates of the forwarding element.

FIG. 3 illustrates a middlebox service comprising multiple forwarding elements and a controller that perform methods of some embodiments.

FIG. 4 illustrates a middlebox service comprising multiple forwarding elements, a controller, and a database that perform methods of some embodiments.

FIG. 5 conceptually illustrates a process to compute adjustments to sampling rates of forwarding elements in some embodiments.

FIG. 6 illustrates an example graph of a sampling rate of a forwarding element changing over time in some embodiments.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for dynamically adjusting sampling rates of a security service. The method configures a forwarding element to collect samples at a first sampling rate as it processes packets. The method analyzes the samples in order to collect information regarding the packets processed by the forwarding element. Based on the analysis, the method detects a new traffic pattern in the packets processed by the forwarding element. The method then configures the forwarding element to collect samples from packets processed by the forwarding element at a second sampling rate different than the first sampling rate.

The second sampling rate in some embodiments is larger than the first sampling rate, and directs the forwarding element to collect a larger number of samples than the first sampling rate. After a transient period of collecting samples at the second sampling rate, the method in some embodiments configures the forwarding element to collect samples from the packets it processes at a third sampling rate that is lower than the second sampling rate. The third sampling rate can be equal to the first sampling rate, or can be a rate between the first and second sampling rates. The third sampling rate causes the forwarding element to collect a smaller number of samples than the second sampling rate because after the transient period, the forwarding element has collected a sufficient number of samples to analyze in order to collect information about the new traffic pattern.

Some embodiments present a feedback control system for a security service in a software defined network. In some embodiments of a software defined network, forwarding elements may transmit useful information to a controller. The controller may learn from this information and extract more intelligent information. Applying the learned intelligent information, the controller can in turn control the behavior of the forwarding elements in capturing and transmitting information to the controller.

Several more detailed embodiments are described below. In many of these embodiments, the method is implemented by a set of one or more controllers that work conjunctively with the forwarding element and other forwarding elements to provide a distributed service (e.g., a middlebox service) in a network. However, one of ordinary skill will realize that in other embodiments, the method is implemented by any type of server to collect and analyze samples from any type of forwarding element that processes packets in order to adjust how much data is sampled by the forwarding element at any given time. Examples of forwarding elements that are used by the methods of some embodiments include switches, routers, gateways, and middlebox service nodes (e.g., load balancers, firewalls, intrusion detection systems, etc.), all or some of which can be implemented as software modules or hardware appliances.

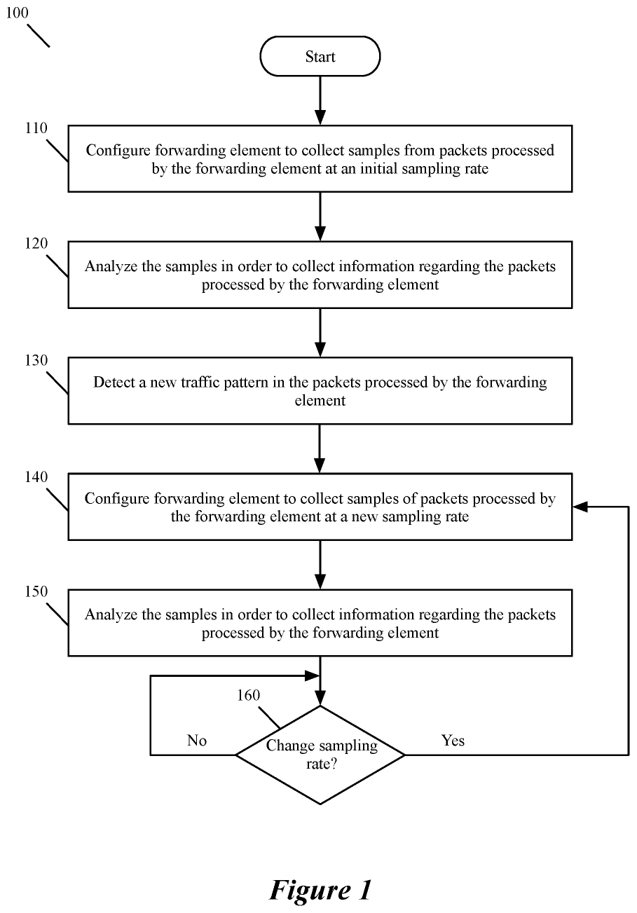

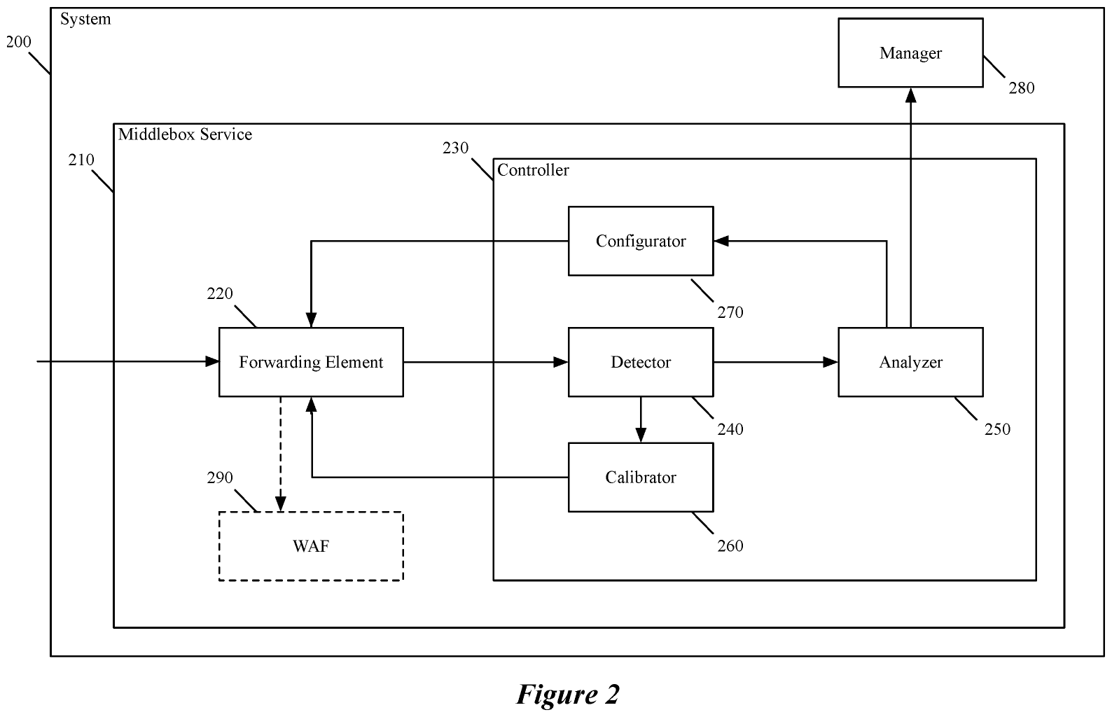

FIG. 1 illustrates a process 100 that implements the method of some embodiments. This figure will be described by reference to an exemplary system 200 illustrated in FIG. 2. The system 200 comprises a middlebox service 210 comprising a forwarding element 220 and a controller 230. The controller comprises a detector 240, analyzer 250, calibrator 260, and configurator 270. The system 200 also comprises a manager 280 outside the middlebox service 210. The process 100 may be performed by components of the controller 230.

The process 100 begins by configuring (at 110) the forwarding element 220 to collect samples from packets processed by the forwarding element 220 at an initial sampling rate. The forwarding element 220 collects samples to forward them to the controller 230 for analyzation. The forwarding element 220 collects samples differently in different embodiments. For instance, in some embodiments, the forwarding element 220 collects samples by copying a subset of packets that the forwarding element 220 processes and forwards the copies to the controller 230. In other embodiments, the forwarding element 220 collects samples by extracting data from a subset of packets that the forwarding element 220 processes and forwards the extracted data to the controller 230. Conjunctively, or alternatively, the forwarding element 220 in some embodiments generates metadata from the data that it extracts from a subset of packets that the forwarding element 220 processes, and then forwards the generated metadata to the controller 230. In some embodiments, the forwarding element 220 forwards to the controller 230 the generated metadata with a portion of the data from the subset of packets.

Next, the process analyzes (at 120) the samples in order to collect information regarding the packets processed by the forwarding element 220. In some embodiments, the detector 240 in the controller 230 receives the samples and uses them to compute an entropy value that expresses a summation of probabilities of all traffic patterns in the packets processed by the forwarding element, such that a change in the entropy over time might indicate when there is a new traffic pattern of packets processed by the forwarding element 220. For instance, when a new traffic pattern emerges, the entropy value will be larger than previously calculated entropy values from when the new traffic pattern did not exist. That is, the derivative of the entropy over time will be greater than zero. Further explanation of the entropy will be described below. In addition to computing the entropy, the detector 240 may generate dynamic metrics. The detector 240 may forward the dynamic metrics to the analyzer 250 to perform numerical and visual analysis of the dynamic metrics. The analyzer 250 performs this analysis to learn about the traffic patterns of the packets processed by the forwarding element 220. Further explanation of the operations by the detector 240 and analyzer 250 will be described below.

Based on the analysis, the process detects (at 130) a new traffic pattern in the packets processed by the forwarding element 220. Detecting a new traffic pattern may be performed differently in different embodiments. In some embodiments, the process detects a new traffic pattern by detecting packets from a new source address, packets to a new destination address, and/or packets using new protocols. New source and destination addresses may include new source and destination layer 3 or layer 4 addresses. As used in this document, the term traffic pattern, flow, traffic flow, or packet flow refers to a set of packets or data messages exchanged between a source network address and a destination network address that share identifying characteristics. In some embodiments, the shared characteristics are an n-tuple (e.g., a 5-tuple made up of header fields such as source Internet Protocol (IP) address, source port number, destination IP address, destination port number, and protocol). A traffic pattern includes one or more packets in a specific transport connection in some embodiments. As stated above, the detector 240 in some embodiments may compute an entropy value that indicates a new traffic pattern has emerged, by showing that the entropy of the system over time has changed. Once the detector 240 detects that there is a new traffic pattern, the calibrator 260 is able to generate an adjustment to the sampling rate. Further discussion of the computation of the adjustment and the operations performed by the calibrator 260 will be discussed below.

Then, the process configures (at 140) the forwarding element 220 to collect samples of packets processed by the forwarding element 220 at a new sampling rate. After the adjustment to the sampling rate has been computed, the adjustment is given to the forwarding element 220 as a set of instructions, rules, or policies to change the initial sampling rate to the new sampling rate. Because a new traffic pattern has been detected, the sampling rate must be increased, so the adjustment is a positive value. When the initial sampling rate is increased to the new sampling rate, the forwarding element 220 collects a larger number of samples than at the initial sampling rate. In some embodiments, the adjustment is a number value to change a sampling rate as a percentage. For instance, the forwarding element 220 may collect samples at a 50% sampling rate, such that the forwarding element 220 collects samples from 50% of the packets processed by the forwarding element 220. If the adjustment is +10%, the forwarding element 220 would then collect samples at a 60% sampling rate. In other embodiments, the sampling rate and adjustment may be represented as values other than percentages.

After the initial sampling rate has changed to the new sampling rate, the forwarding element 220 will continue to sample packets and forward them to the controller 230. The process will again analyze (at 150) the samples in order to collect information regarding the packets processed by the forwarding element 220. The detector 240 in some embodiments receives these samples and uses them to compute an entropy value similarly to operation 120.

Next, the process will determine (at 160) whether to change the sampling rate. The process will change the sampling rate in some embodiments if there is another new traffic pattern of packets processed by the forwarding element 220, and/or the analyzer 250 has not learned all information about all traffic patterns of the packets. In these cases, the sampling rate may be increased, so the process returns to 140 to configure the forwarding element 220 to collect samples of packets processed by the forwarding element 220 at a new, higher sampling rate. In other embodiments, the process will change the sampling rate if there are no new traffic patterns and the analyzer 250 has learned all information about all traffic patterns of the packets. In this case, the process returns to 140 to configure the forwarding element 220 to collect samples of packets processed by the forwarding element 220 at a new, lower sampling rate. This new, lower sampling rate may be the same as the initial sampling rate, or may be between the previous new sampling rate and the initial sampling rate.

At 160, the process in some embodiments may also determine to not change the sampling rate. This may happen if there are no new traffic patterns and the analyzer 250 has not learned all information about all current traffic patterns of packets processed by the forwarding element 220 so the controller 230 still requires a larger number of samples. Alternatively, this may happen if the analyzer 250 has learned all information about the new traffic pattern of packets processed by the forwarding element 220, but another new traffic pattern emerges that the analyzer 250 must learn. In either case, the process will continue to collect samples at the current sampling rate in order to learn information about all traffic patterns, and will iteratively reevaluate changing the sampling rate.

The process 100 is performed to dynamically collect and analyze samples of packets processed by the forwarding element 220 in order to provide middlebox services. The analyzer 250 learns about traffic patterns of the packets to determine when a middlebox service needs to be performed. For instance, when the middlebox service is a security service, if a new traffic pattern is detected and the analyzer 250 learns that this traffic pattern is pernicious, the analyzer 250 may alert the configurator 270, and the configurator 270 may configure the forwarding element 220 to drop the packets associated with the newly detected traffic pattern (e.g., the packets coming from a newly detected source network address). In some embodiments, the forwarding element 220 is a web application firewall (WAF).

Alternatively, in other embodiments, the forwarding element 220 is not a WAF but is a forwarding element 220 that first processes the packets. In some embodiments, the forwarding element 220 uses a WAF 290 to analyze packets associated with a newly detected traffic pattern. The WAF 290 is drawn with dashed lines in FIG. 2 in order to emphasize that it is not used in all embodiments. In some of these embodiments, the configurator 270 configures the forwarding element 220 to forward to the WAF 290 the subset of packets that are associated with the newly detected traffic pattern (e.g., the packets coming from a newly detected source network address) for the WAF 290 to analyze to determine whether this traffic should be dropped. Instead of using a WAF, the configurator 270 in some embodiments configures a forwarding element to forward this subset of packets to a deep packet inspector or another middlebox forwarding element to analyze.

This approach helps mitigate the workload of deep inspection, as it first provides a shallow inspection which is fast and executed before the deep inspection process is performed. Depending on the result of the shallow inspection, the costly deep inspection is unnecessary for most of the traffic when there are no new traffic events. In other words, some embodiments of the invention provide a novel solution that first performs a shallow inspection to identify legitimate traffic.

If incoming traffic is inspected and deemed to be legitimate traffic, with enough confidence, the traffic is permitted without further going through the costly deep inspection, thereby increasing system performance. Shallow inspection provides an express lane for the traffic. Examples of legitimate traffic include requests of ecommerce URLs on the World Wide Web. A URL (Uniform Resource Locator) normally contains a path and a group of parameters associated with the path. Each parameter may have a name and a value. A parameter may have just a name without a value, referred to as a binary parameter. A binary parameter can be considered a regular parameter with a null value. The values of the parameters have characteristics of belonging to only certain categories such as English letters, digits, combination of letters and digits, etc. For example, if a parameter is a zip code of the United States, then the value of the zip code can only take numerical digits. The length of the parameter values is also a distinguishing property of a parameter. Other distinguishing properties associated with a parameter value can be extracted and used. The URLs can be used for machine learning and identifying legitimate traffic.

To identify legitimate traffic, some embodiments first learn data and then use the learned knowledge to perform the shallow inspection process for determining a decision. Oftentimes, learning data is captured on the fly from real-time traffic flows, without an available predefined set of data samples for learning. The learning data is fed to the machine learning module which also performs learning on the fly. Network traffic may evolve over time, changing its characteristics and patterns, hence the captured learning data evolves accordingly. The dynamic nature of learning data poses a challenge for machine learning systems. There is a need to monitor and measure the progress of dynamic machine learning. Based on the progress, resource allocation can be dynamically adjusted by controlling the behavior of the forwarding devices in a software defined network.

Alternatively, or conjunctively with the above-described embodiments, the analyzer 250 in some embodiments also sends alerts to a network manager 280 regarding potentially pernicious traffic patterns. Also, in some of the above-described embodiments, the middlebox service 210 that samples the packets is a WAF service. In other embodiments, the middlebox service that performs this sampling is another type of middlebox service (e.g., a load balancing service), which upon detection of a new traffic pattern, re-routes the packets to a security service (such as a WAF service) to perform a security operation on the new traffic pattern. By dynamically adjusting the sampling rate, the middlebox service 210 is able to conserve resource consumption while still optimizing performance.

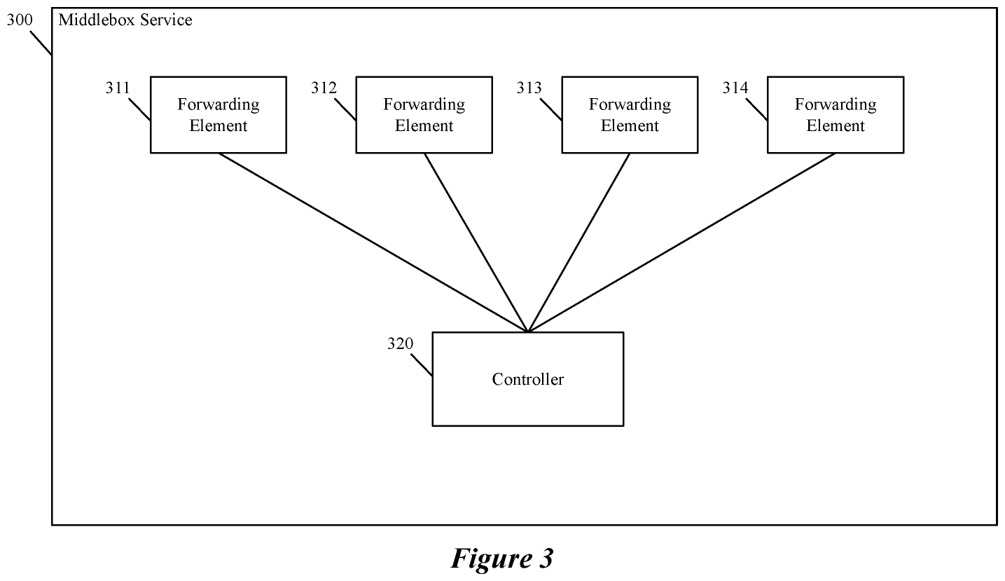

FIG. 3 illustrates another example embodiment of a middlebox service 300. In this example, forwarding elements 311, 312, 313, and 314 are connected to a controller 320. In some embodiments, each of the forwarding elements 311, 312, 313, and 314 sends samples to the controller 320. The middlebox service 300 may perform methods similar to process 100 in some embodiments. When configuring the forwarding elements 311, 312, 313, and 314 to collect samples at a new sampling rate, the controller 320 may directly forward the set of instructions, including the adjustments, to the forwarding elements 311, 312, 313, and 314. Each of the forwarding elements 311, 312, 313, and 314 may collect samples at the same sampling rate or may collect samples at different sampling rates. In different embodiments, the forwarding elements 311, 312, 313, and 314 may process packets of the same traffic patterns or may each process packets of different traffic patterns such that no two forwarding elements process packets of the same traffic pattern.

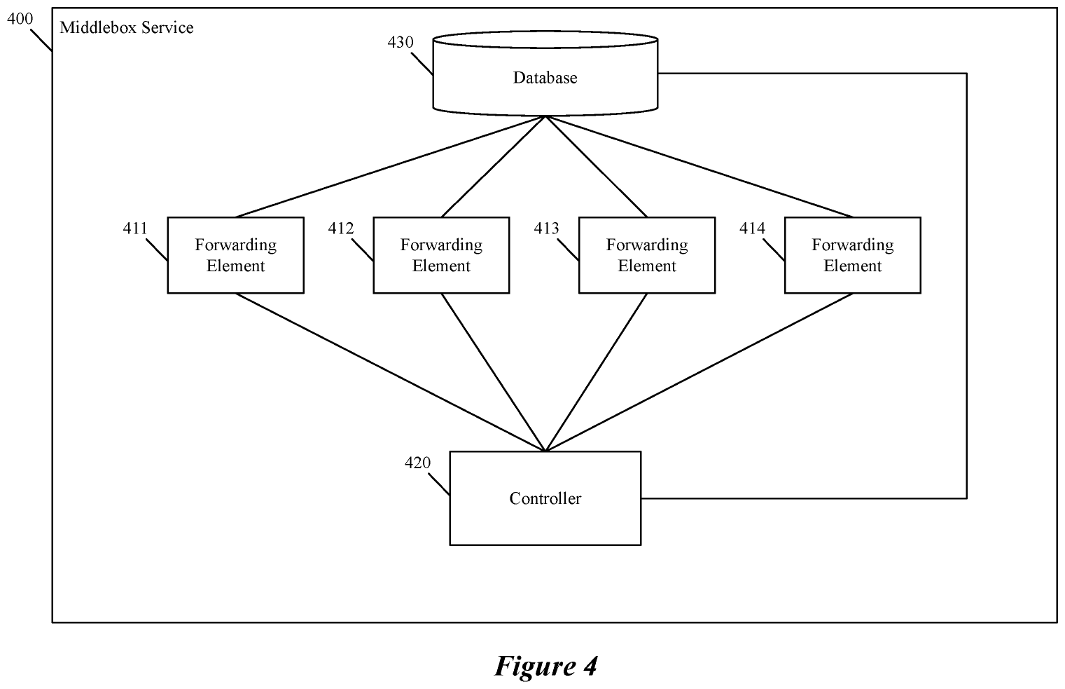

FIG. 4 illustrates another example embodiment of a middlebox service 400. The middlebox service 400 may perform methods similar to process 100 in some embodiments. In this example, when configuring the forwarding elements 411, 412, 413, and 414 to collect samples at a new sampling rate, the controller 420 may store the set of instructions including the adjustments to the database 430, and the forwarding elements 411, 412, 413, and 414 periodically retrieve the set of instructions from the database 430 to adjust their sampling rates. In some embodiments, each of the forwarding elements 411, 412, 413, and 414 sends samples to the controller 420. In other embodiments, the forwarding elements stores the samples in the database 430 and the controller 420 retrieves the samples from the database 430. Similar to the middlebox service 300, each of the forwarding elements 411, 412, 413, and 414 may collect samples at the same sampling rate or may collect samples at different sampling rates. In different embodiments, the forwarding elements 411, 412, 413, and 414 may process packets of the same traffic patterns or may each process packets of different traffic patterns such that no two forwarding elements process packets of the same traffic pattern. Other types of services such as a file server, a HTTP portal server, or a cache server may replace the database 430 or work as a supplement to the database 430.

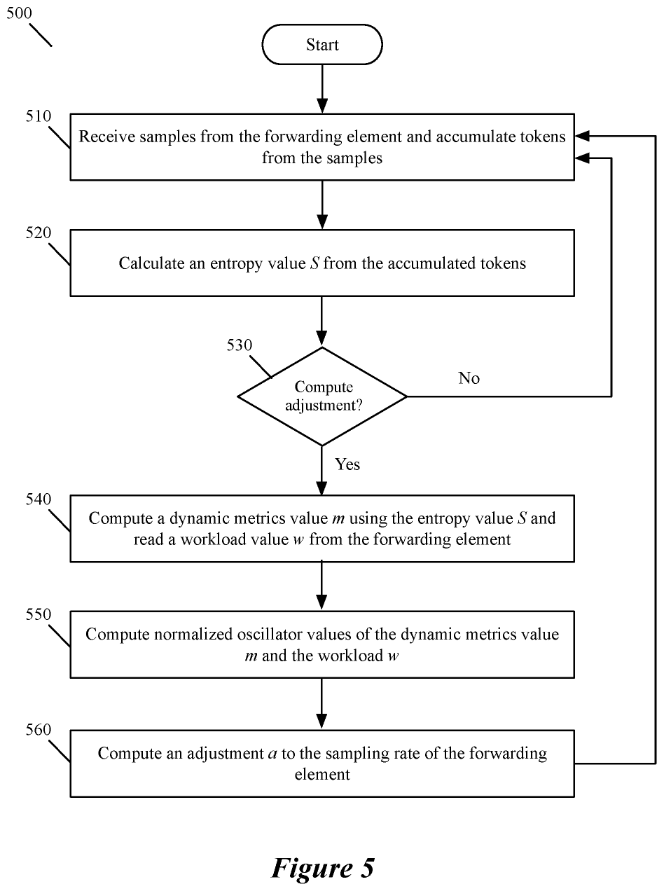

FIG. 5 conceptually illustrates a process 500 for computing adjustments to sampling rates. This figure will be described by reference to the exemplary system 200. The process 500 may be performed by components of the controller 230 to compute adjustments “a” to sampling rates implemented by the forwarding element 220. In some embodiments, the process 500 is performed iteratively as long as the forwarding element is processing packets.

The process begins by receiving (at 510) samples from the forwarding element 220 and accumulating tokens from the samples. The samples in different embodiments may be packets copied at the forwarding element 220, data extracted from packets, or metadata generated from extracted data. In some embodiments, the tokens uniquely represent patterns of the samples. For instance, packets in the World Wide Web mainly includes HTTP requests and responses. Therefore, the samples may be related to the URL of HTTP requests. A URL generally includes a path component and a query component. The query component has multiple name-value (or key-value) pairs or names without values. The names or keys are called parameters in the query component. The values associated with the names or keys are categorized into various types. The values also have characteristics of certain lengths. Hence, the tokens may include the path, query parameters including type and length of the values, or other strings of the URL. In some embodiments, the tokens may be parameters of the samples, and the parameters may have one or more n-tuple values (e.g., source IP address, source port number, destination IP address, destination port number, and protocol). In other embodiments, other parameters may be used. In some embodiments, the tokens are accumulated in the detector 240 and ordered by the time they arrive at the detector 240. For capacity reasons, some embodiments may periodically drop older tokens to reduce memory usage. In some embodiments, the tokens may also be permanently stored on a disk for persistence.

The process then computes (at 520) an entropy value S from the accumulated tokens. In some embodiments, the entropy S expresses a summation of all probabilities of all traffic patterns in the packets processed by the forwarding element 220. In some embodiments, the detector 240 calculates the entropy S using the following expression:

S=−Σᵢ₌₁^{N}pᵢ log pᵢ

where pᵢ is the probability of the i-th token in the number N of tokens accumulated, i=1, 2, . . . N, log is the two-based logarithm function, and S is the entropy value of the middlebox service at a certain point in time. In some embodiments, with {t₁, t₂, t₃, . . . , tₘ} representing the time sequence when each group of tokens in the samples is received by the detector 240, the probability of pᵢ at time tₘ may be determined by:

$${p}_{i}^{m} = \frac{{\sum }_{j = 1}^{m} {c}_{i}^{j} {e}^{λ ( {t}_{j} - {t}_{m} )}}{{\sum }_{i = 1}^{N} {\sum }_{j = 1}^{m} {c}_{i}^{j} {e}^{λ ( {t}_{j} - {t}_{m} )}}$$

where cᵢ^{j} is the count of the i-th token at time j, e stands for the exponential function, and λ is a damping coefficient. In some embodiments, the value of the probability discounts old tokens and relies more heavily on recent tokens received. In some embodiments, if the number N of tokens exceeds the memory resource constraints of the system, the tokens can be hashed into a predefined number of buckets where the bucket number of each bucket identifies the tokens inside the bucket. A bucket may be a container for holding the tokens that are hashed into the bucket. Alternatively, the entropy value S may be determined by not discounting any older tokens. This may be achieved by setting λ to zero such that all tokens are collectively saved in one bucket and the entropy value S is computed and stored successively at different points in time. In some embodiments, the detector 240 is able to detect a new traffic pattern of packets processed by the forwarding element 220 because the entropy S has increased. In some embodiments, the detector 240 compares the entropy value S to previously computed entropy values, and if the entropy value S is greater, then there is a new traffic pattern. Alternatively, or conjunctively, the detector 240 can compute the first derivative of the entropy value S′ with respect to time, and there is a new traffic pattern if the derivative of the entropy S′ is greater than zero.

The process then determines (at 530) whether it should compute an adjustment factor based on the computed entropy value. If not, it returns to 510 to process additional received samples. Otherwise, the process computes (at 540) a dynamic metrics value m using the entropy value S. In some embodiments, the detector 240 computes this using the following expression:

m=S*e^{(S′/f)}

where S′ is the first-order derivative of the entropy S with respect to time and e stands for the exponential function. In different embodiments, the number f is any fractional number and can be replaced by 1, 2, 4, or any other number. In some embodiments, a different expression including the values of S and any derived values of S can be applied for obtaining the dynamic metrics value m. That is, m can be a function of S and any order of derivatives of S with respect to time. In some embodiments, the value of m may be used as a factor in adjusting sampling rates of one or more forwarding elements. In other embodiments, m is used as a factor in an expression involving a sigmoid function with respect to the values of S and S′.

Also at operation 540, the process reads a workload w from the forwarding element 220. In some embodiments, the workload is also read from one or more other components in the middlebox service. In some embodiments, the workload w may express the resource consumption of the middlebox service used to perform its operations and may include CPU usage, memory usage, network resource, or any type of system resource. In some embodiments, the workload w can be obtained as a weighted average of all its components. The workload w may be used as another factor in adaptively adjusting sampling rates of one or more forwarding elements. In some embodiments, the steps computation and reading operations of 540 may be executed in parallel or sequentially without significant differences.

The process then computes (at 550) normalized oscillator values of the dynamic metrics value m and the workload w. In some embodiments, the normalized oscillator values are computed because the values of the dynamic metrics m and the workload w are very large. In some embodiments, the detector 240 forwards the dynamic metric and workload values to the calibrator 260 to perform operation 550. In some embodiments, the normalized oscillator values may be computed using the following expression:

$$O ( v ) = \frac{v - min ( v , K )}{max ( v , K ) - min ( v , K )}$$

where ν can be applied to either m or the workload w, min(ν,K) is the minimum value of ν in the last K time intervals including present time, and max(ν,K) is the maximum value of ν in the last K time intervals including present time. In different embodiments, K can take the value of 3, 4, 5, 6, 7, 8, 9, 10, or any other values. In some embodiments, the range of the normalized oscillator values O(v) may be between zero and one, inclusive. In some embodiments, when max(ν,K) is equal to min(ν,K), the value of O(v) is zero. In some embodiments, the normalized oscillator values are time-series values.

The process then computes (at 560) an adjustment a to the sampling rate of the forwarding element. In some embodiments, the adjustment a is produced by the calibrator 260 using the following expression:

a=x*[O(m)−0.5]−y*[O(w)−0.5]

where O(m) and O(w) are the normalized oscillator values of the dynamic metrics value m and the workload w, respectively. The value of x is the positive contributing factor relating to the dynamic metrics value m, and y is the negative contributing factor relating to the workload w. In some embodiments, the values of both x and y are positive, and the sum of x and y is less than 2. In some embodiments, when a new traffic pattern is detected, the adjustment value a is a positive value to increase the sampling rate. In other embodiments, the adjustment value a may be a negative value to decrease the sampling rate. For instance, when the analyzer 250 has learned about all traffic patterns of packets processed by the forwarding element 220, the sampling rate should be decreased to reduce the resource usage and consumption of the middlebox service 210 in order to optimize its performance. So, the calibrator 260 computes a negative adjustment value a and the forwarding element 220 decreases its sampling rate.

In some embodiments, the value of the adjustment a modifies the sampling rate by the following expression:

s=r+a

where r is the value for the previously used sampling rate of the forwarding element 220, a is the adjustment computed by the calibrator 260, and s is the value for the newly modified sampling rate. In some embodiments, it can be understood from these expressions that an increase of the entropy value S leads to an increase of the sampling rate, and an increase in workload tends to reduce the sampling rate.

In some embodiments, at each iteration of the process 500, the adjustment value a can be limited to a predefined value for incremental updates. That is, the adjustment is performed in small steps to prevent wild swings of the value of the sampling rate of the forwarding element 220. In other embodiments, any workload component such as CPU usage or memory usage is examined and compared to a threshold. If a workload component or a multitude of workload components exceeds the threshold, the component with the maximum value is used in computing the normalized oscillator value of the workload.

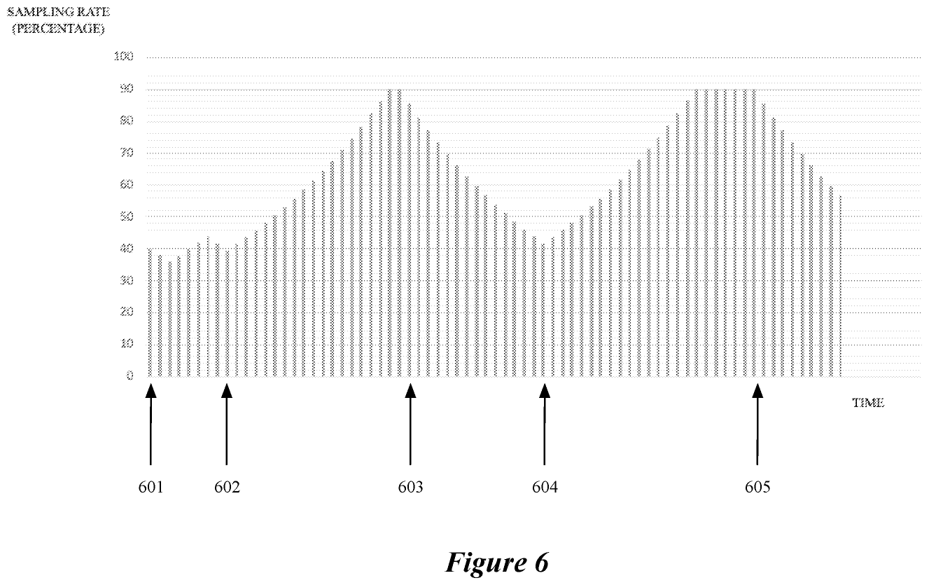

FIG. 6 illustrates an example graph showing the change of a sampling rate of a forwarding element 220 over time. In this example, the sampling rate is represented by a percentage of packets to be sampled by the forwarding element 220. In such embodiments, the higher the percentage, the more samples the forwarding element 220 collects. At the first marker 601, the sampling rate is set arbitrarily to 40%. When the sampling rate is at 40%, the forwarding element 220 collects samples from 40% of the packets processed by the forwarding element 220. In some embodiments, these samples are sent to the controller 230 to analyze the samples and detect new traffic patterns of packets.

At the second marker 602, the controller 230 has detected a first new traffic pattern, generated an adjustment a to the sampling rate, and forwarded the adjustment a to the forwarding element 220. In some embodiments, the controller 230 detects the first new traffic pattern by using the samples collected by the forwarding element 220. In some embodiments, the controller 230 computes an entropy value S which determines whether there is a new traffic pattern. In this example, the adjustment a to the sampling rate is to increase the sampling rate so the forwarding element 220 can collect samples from a larger percentage of packets so the controller 230 can receive a larger number of samples to learn about the first new traffic pattern. After this marker 602, the sampling rate of the forwarding element 220 increases up to 90%.

At the third marker 603, the controller 230 has successfully learned about the first new traffic pattern and does not need to learn any new information about any current traffic patterns of packets processed by the forwarding element 220. In some embodiments, when this occurs, the controller 230 computes an adjustment a to decrease the sampling rate of the forwarding element 220. In such embodiments, the sampling rate is decreased to conserve resource consumption of the components in the middlebox service 210 in order to optimize its performance. After this marker 603, the sampling rate of the forwarding element 220 decreases back down to approximately 40%. The samples collected by the forwarding element 220 are still forwarded to the controller 230 so the controller can analyze the samples to detect when another new traffic pattern emerges.

At the fourth marker 604, the controller 230, still receiving and analyzing all samples, detects a second new traffic pattern of packets processed by the forwarding element 220, generates a new adjustment a to the sampling rate, and forwards the adjustment a to the forwarding element 220. As with marker 602, the controller 230 detects the second new traffic pattern using the samples collected by the forwarding element 220. In some embodiments, the controller 230 computes an entropy value S which determines whether there is a new traffic pattern. In this example, the adjustment a to the sampling rate is to increase the sampling rate so the forwarding element 220 can collect samples from a larger percentage of packets so the controller 230 can receive a larger number of samples to learn about the second new traffic pattern. After this marker 604, the sampling rate of the forwarding element 220 increases back up to 90%.

At the final marker 605, the controller 230 has successfully learned about the second new traffic pattern and once again does not need to learn any new information about any current traffic patterns of packets processed by the forwarding element 220. In some embodiments, as with marker 603, the controller 230 computes an adjustment a to decrease the sampling rate of the forwarding element 220. The sampling rate is decreased again to conserve resource consumption of the components in the middlebox service 210 in order to optimize its performance. After this marker 605, the sampling rate of the forwarding element 220 decreases back down to approximately 60%. The samples collected by the forwarding element 220 will continue to be forwarded to the controller 230 so the controller can analyze the samples to detect when another new traffic pattern emerges. Hence, in some embodiments, the feedback control system of the middlebox service can adaptively adjust the sampling rates of one or more forwarding elements and optimize system resource usage.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

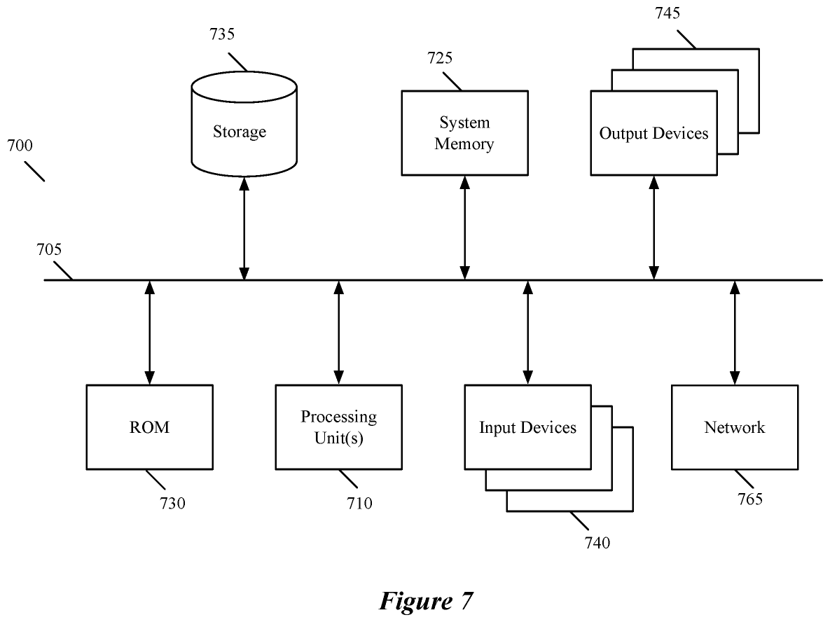

FIG. 7 conceptually illustrates a computer system 700 with which some embodiments of the invention are implemented. The computer system 700 can be used to implement any of the above-described computers and servers. As such, it can be used to execute any of the above described processes. This computer system includes various types of non-transitory machine readable media and interfaces for various other types of machine readable media. Computer system 700 includes a bus 705, processing unit(s) 710, a system memory 725, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 725, and the permanent storage device 735.

From these various memory units, the processing unit(s) 710 retrieve instructions to execute and data to process in order to execute the processes of the invention. The processing unit(s) may be a single processor or a multi-core processor in different embodiments. The read-only-memory (ROM) 730 stores static data and instructions that are needed by the processing unit(s) 710 and other modules of the computer system. The permanent storage device 735, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a flash drive, etc.) as the permanent storage device. Like the permanent storage device 735, the system memory 725 is a read-and-write memory device. However, unlike storage device 735, the system memory is a volatile read-and-write memory, such a random access memory. The system memory stores some of the instructions and data that the processor needs at runtime. In some embodiments, the invention's processes are stored in the system memory 725, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices enable the user to communicate information and select commands to the computer system. The input devices 740 include alphanumeric keyboards and pointing devices (also called “cursor control devices”). The output devices 745 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 7, bus 705 also couples computer system 700 to a network 765 through a network adapter (not shown). In this manner, the computer can be a part of a network of computers (such as a local area network (“LAN”), a wide area network (“WAN”), or an Intranet, or a network of networks, such as the Internet. Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for dynamically adjusting sampling rates of a security service, the security service comprising a forwarding element and a set of one or more controllers, the method comprising:
configuring the forwarding element to collect samples from packets processed by the forwarding element at a first sampling rate;
analyzing the samples in order to collect information regarding the packets processed by the forwarding element;
detecting, based on the analysis, a new traffic pattern in the packets processed by the forwarding element; and
configuring the forwarding element to collect samples from packets processed by the forwarding element at a second sampling rate different than the first.

2. The method of claim 1, wherein the second sampling rate causes the forwarding element to collect a larger number of samples than the first sampling rate.

3. The method of claim 2 further comprising configuring, after a transient period of collecting samples at the second sampling rate, the forwarding element to collect samples processed by the forwarding element at a third sampling rate that is lower than the second sampling rate.

4. The method of claim 3, wherein the third sampling rate causes the forwarding element to collect a smaller number of samples than the second sampling rate because after the transient period, the forwarding element has collected a sufficient number of samples to analyze in order to collect information about the new traffic pattern.

5. The method of claim 3, wherein configuring the forwarding element to collect samples at the third sampling rate comprises generating and forwarding a set of instructions to the forwarding element, the instruction set computing an adjustment value to change the second sampling rate to the third sampling rate.

6. The method of claim 1, wherein the configuring, analyzing, and detecting operations are performed by the set of one or more controllers.

7. The method of claim 6, wherein the forwarding element collects samples by copying a subset of packets that the forwarding element processes and forwarding the copies to the controller set.

8. The method of claim 6, wherein the forwarding element collects samples by extracting data from a subset of packets that the forwarding element processes and forwarding the extracted data to the controller set.

9. The method of claim 6, wherein the forwarding element collects samples by extracting data from a subset of packets that the forwarding element processes, generating metadata from the extracted data, and forwarding the metadata to the controller set.

10. The method of claim 9, wherein the forwarding element forwards a portion of the extracted data to the controller set along with the generated metadata.

11. The method of claim 6, wherein configuring the forwarding element to collect samples at the second sampling rate comprises generating and forwarding a set of instructions to the forwarding element, the instruction set computing an adjustment value to change the first sampling rate to the second sampling rate.

12. The method of claim 11, wherein computing the adjustment value comprises:
computing, from the collected samples, an entropy value that expresses a summation of probabilities of all traffic patterns in the packets processed by the forwarding element;
computing, from a dynamic metric value and a workload value, first and second normalized oscillator values that express normalized values for the dynamic metric value and the workload value; and
computing, using the first and second normalized oscillator values, the adjustment value.

13. The method of claim 12, wherein
computing the entropy value further comprises using a set of tokens accumulated from the collected samples,
the dynamic metric value is computed using the entropy value, and
the workload value is collected by the controller set and expresses resource consumption of the security service.

14. The method of claim 13, wherein the set of tokens specifies parameters of the collected samples.

15. The method of claim 14, wherein the parameters comprise at least one of a name value and a length.

16. A non-transitory machine readable medium storing a program for dynamically adjusting sampling rates of a security service, the security service comprising a forwarding element and a set of one or more controllers, the program comprising sets of instructions for:
configuring the forwarding element to collect samples from packets processed by the forwarding element at a first sampling rate;
analyzing the samples in order to collect information regarding the packets processed by the forwarding element;
detecting, based on the analysis, a new traffic pattern in the packets processed by the forwarding element; and
configuring the forwarding element to collect samples from packets processed by the forwarding element at a second sampling rate different than the first.

17. The non-transitory machine readable medium of claim 16, wherein the second sampling rate causes the forwarding element to collect a larger number of samples than the first sampling rate.

18. The non-transitory machine readable medium of claim 17, wherein the program further comprises a set of instructions for configuring, after a transient period of collecting samples at the second sampling rate, the forwarding element to collect samples processed by the forwarding element at a third sampling rate that is lower than the second sampling rate.

19. The non-transitory machine readable medium of claim 16, wherein the set of instructions for detecting a new traffic pattern comprises a set of instructions for detecting one of (i) packets from a new source address, (ii) packets to new destination address, and (iii) packets using new protocols.

20. The non-transitory machine readable medium of claim 19, wherein new source and destination addresses include new source and destination layer 3 or layer 4 addresses.
